(19) United States
(12) Patent Application Publication
(10) Pub. No.: US 2014/0009041 A1
(43) Pub. Date: Jan. 9, 2014

(54) ROTATING ELECTRICAL MACHINE

(71) Applicant: Hitachi Automotive Systemns., Ltd., Hitachinaka-shi (JP)

(72) Inventors: Shozo KAWASAKI, Hitachinaka (JP); Junnosuke NAKATSUGAWA, Hitachi (JP); Kenji NAKAYAMA, Hitachi (JP); Hiroshi KANAZAWA, Hitachiota (JP); Yasunaga HAMADA, Hitachinaka (JP)

(21) Appl. No.: 13/936,681

(22) Filed: Jul. 8, 2013

(30) Foreign Application Priority Data
Jul. 9, 2012 (JP) 2012-153156

(51) Int. Cl. H02K 5/16

(52) U.S. Cl. CPC H02K 5/161
USPC 310/425

(57) ABSTRACT

Inner rings of bearings arranged at both ends of a rotor shaft are fixed to the rotor shaft, and outer rings of both of the bearings are arranged at bearing holding parts movably in an axial direction of the rotor. A preload imparting member is attached to one of the bearings, the preload imparting member being configured to bias the rotor shaft in one direction and to apply a biasing force to make a housing and a flange, which constitute a chassis, come close to each other.

### BACKGROUND OF THE INVENTION

1. Field of the Invention

The present invention relates to a rotating electrical machine, and particularly to a rotating electrical machine with both ends of a rotor shaft thereof supported by bearings.

2. Description of the Related Art

Rotating electrical machines such as motors and generators have been used in many industrial fields. As a social trend, rotating electrical machines capable of saving energy and resources have been demanded. Therefore, many improvement technologies have been proposed to meet the demand for saving energy and resources. As a major technological subject of saving energy and resources, there is a technology for reducing the size or weight of a rotating electrical machine.

For example, an in-vehicle rotating electrical machine of an automobile or the like is preferably small with excellent quietness and mountability, not to mention output performance.

More specifically, a rotating electrical machine used for an electric power steering device for steering an automobile is generally arranged on a rack shaft, which is arranged in the vehicle interior or in an engine room near the vehicle interior.

This naturally limits the location where the rotating electrical machine can be mounted. Therefore, noise generated upon the operation of the rotating electrical machine may make an occupant inside the vehicle feel uncomfortable.

In recent years, operating noise to be generated by the components of an automobile has been attracting attention as one of the criteria for evaluating the automobile. It is required, therefore, to take some countermeasures against operating noise to be generated by the components used, in pursuit of comfort of an automobile or in terms of environmental regulations.

As a result, there have been proposed various technologies for reducing noise to be generated by a motor of an electric power steering device.

For example, the technology disclosed in JP 2009-201255 A (Patent Document 1) takes the following measure for reducing abnormal noise to be generated by the backlash of a rotor shaft in its axial direction.

That is, in a rotating electrical machine with both ends of the rotor shaft rotatably supported by bearings, the rotor shaft is press fit and fixed into an inner ring of the bearing at one end, an outer ring of the bearing at the other end is press fit and fixed into a housing, and an outer ring of the bearing at the one end is elastically biased by a preload spring. With this configuration, the rotor shaft is moved together with the bearing at the one end and, along with this movement, the rotor shaft is moved inside an inner ring of the bearing at the other end and pushed in one direction. In this manner, the movement of the rotor shaft in its axial direction is regulated, thereby suppressing abnormal noise to be generated by the backlash of the rotor shaft.

### SUMMARY OF THE INVENTION

However, the rotating electrical machine disclosed in Patent Document 1 is not configured to be satisfactorily small for the reasons described below.

In the rotating electrical machine disclosed in Patent Document 1, the rotor shaft is supported by a case-side bearing and a flange-side bearing. The case-side bearing includes an inner ring and an outer ring supported by a case. The flange-side bearing includes an inner ring and an outer ring supported by a flange. The rotor shaft is press fit and fixed into the inner ring of the case-side bearing, and the outer ring thereof is held by the case displaceably in the axial direction.

On the other hand, the rotor shaft is inserted into the inner ring of the flange-side bearing displaceably in the axial direction, while the outer ring thereof is press fit and fixed into the flange.

A wave washer serving as a preload imparting member is arranged outside the flange-side bearing (opposite to the rotor across the bearing arranged on the rotor shaft). This wave washer pushes the inner ring of the flange-side bearing toward the rotor. With this configuration, the elastic force of the wave washer is transmitted to the inner ring of the case-side bearing via the rotor shaft to further move the outer ring.

As a result, the rotor shaft is pushed toward the case-side bearing, making it possible to suppress the generation of abnormal noise.

However, the wave washer serving as a preload imparting member is arranged outside the flange-side bearing (opposite to the rotor across the bearing arranged on the rotor shaft). Therefore, with the rotor shaft pushed toward the case, the elastic force of the wave washer acts as a reaction force in the direction of separating the case and the flange.

This makes it necessary to firmly fix the case and the flange with a fixing screw. Since the case and the flange are fixed with the fixing screw, the outer shape of the rotating electrical machine has a bulge corresponding to this fixing portion, making it difficult to reduce the size of the machine.

On the other hand, in the case where the outer shape of the rotating electrical machine is determined so as to accommodate the machine in a limited mounting space, it is necessary to secure a fixing portion by a fixing screw. This makes it difficult to increase the dimensions of a stator and a rotor, which determine an actual torque, thus inhibiting high output.

An object of the present invention is to provide a small rotating electrical machine excellent in quietness.

Features of the present invention are as follows. That is, the rotor shaft is biased in one direction, and a preload imparting member is attached to one of the bearings. The preload imparting member applies a biasing force to make a housing and a flange, which constitute a chassis, come close to each other.

According to the present invention, by pushing the rotor shaft in one direction with the preload imparting member, it is possible to suppress abnormal noise to be generated by the backlash of the rotor shaft in the axial direction.

With a retaining force obtained to make the housing and the flange come close to each other, it is possible to enhance the effect of integrally holding the housing and the flange. This makes it possible to eliminate, or reduce the size of, the fixing screw that has been used to fix the housing and the flange. Therefore, the outer shape of the rotating electrical machine can be made small by a portion corresponding to this fixing portion, making the machine smaller.

### BRIEF DESCRIPTION OF THE DRAWINGS

FIG. 1 is an external view of a rotating electrical machine to which the present invention is applied;

FIG. 2 is a vertical cross-sectional view of a rotating electrical machine, in its axial direction, according to an embodiment of the present invention;

FIG. 3 is an external perspective view of a rotor illustrated in FIG. 2; and

FIG. 4 is a cross-sectional view of a bearing illustrated in FIG. 2.

### DESCRIPTION OF THE PREFERRED EMBODIMENTS

Embodiments of the present invention will be described in detail below with reference to the drawings. The present invention, however, is not limited to the embodiments described below, and includes various modifications and applications within the technical concept of the present invention.

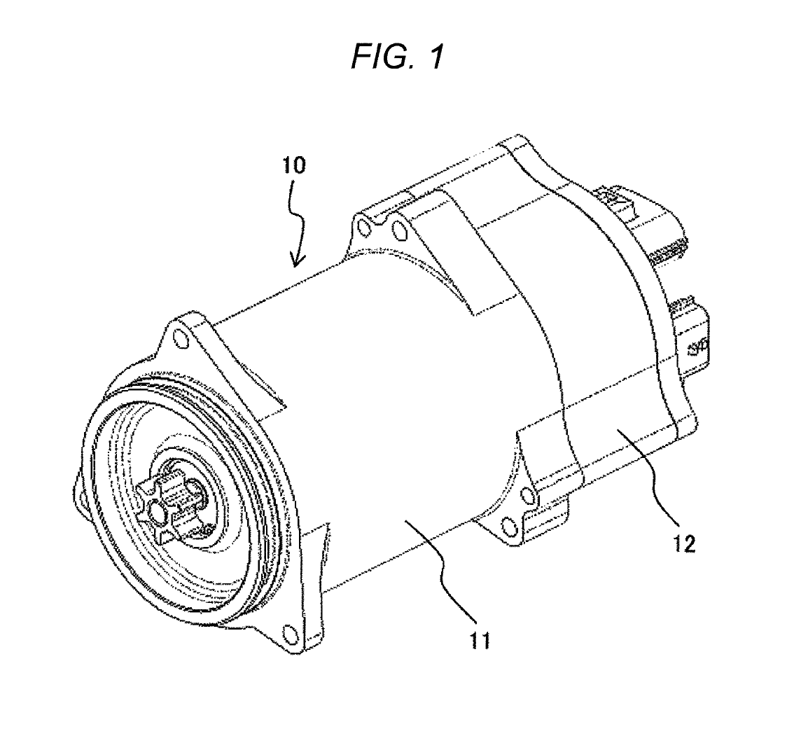

FIG. 1 is a view of a rotating electrical machine assembly 10 used in an electric power steering device as an example. The rotating electrical machine assembly 10 includes a rotating electrical machine 11 and an inverter controller 12 for controlling the driving of the rotating electrical machine 11.

The inverter controller 12 includes, inside a chassis thereof, a power semiconductor element constituting an inverter circuit, a drive circuit for driving the power semiconductor element, and a control circuit for controlling the drive circuit.

The rotating electrical machine 11 and the inverter controller 12 are firmly fixed to each other with a dedicated fixing bolt. In this state, the rotating electrical machine assembly 10 is integrated with a power steering device (not illustrated) with a through bolt, for example.

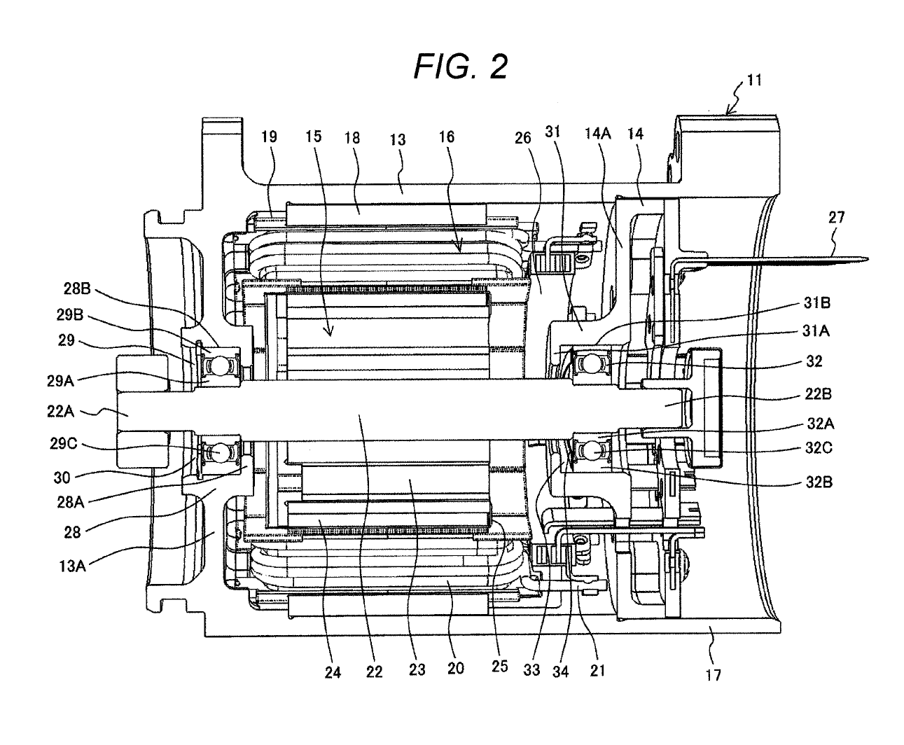

Next, the detailed configuration of the rotating electrical machine 11 with the inverter controller 12 removed from the rotating electrical machine assembly 10 will be described with reference to FIG. 2.

FIG. 2 is a cross-sectional view illustrating a vertical cross-section, in the axial direction, of the rotating electrical machine 11. The rotating electrical machine 11 mainly includes a housing 13 and a flange 14, which constitute a chassis, and a rotor 15 and a stator 16, which constitute a motor.

The housing 13 is formed in the shape of a bottomed cylinder (so-called cup shape) having an opening 17 at one end. The flange 14 is fixed to the housing 13 so as to cover the opening 17.

The stator 16 is fixed to the inner periphery of the housing 13. Divided fixing cores 18 constitute the stator 16, and are fixed through press fitting or shrinkage fitting while maintaining a circular shape. The divided fixing cores 18 are formed in the circular shape with divided surfaces thereof welded or not welded.

A bobbin 19 is attached to the fixing core 18. A coil 20 is wound around the outer periphery of the bobbin 19. A lead wire of the coil 20 is connected to a bus bar 21. Note that the coil 20 is wound continuously two or four times, after which the lead wire is protruded. Alternatively, the coil 20 is connected to the bus bar 21 while being wound around each fixing core 18. The housing 13 and the bobbin 19 may interpose a gap therebetween, or may be fitted to each other.

The bus bar 21 is arranged in the vicinity of the inner wall surface of the housing 13 such that a bearing holding part 31 described later is located on the inner periphery. Of course, the bus bar 21 and the housing 13 are arranged at locations separate from each other where air insulation can be ensured therebetween.

The rotor 15 is rotatably arranged on the inner periphery side of the fixing core 18. The rotor 15 includes a rotor shaft 22, a rotating base 23, a magnet 24, and a magnet cover 25.

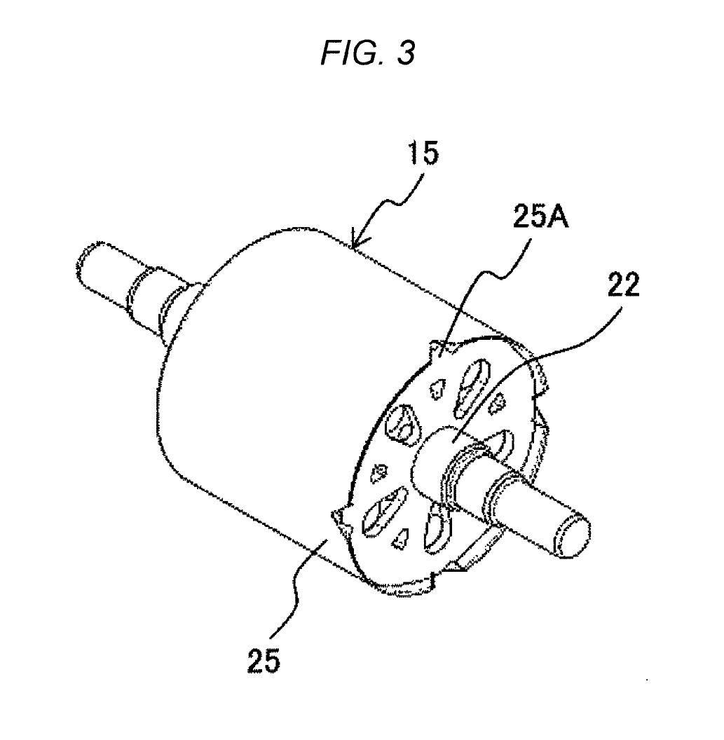

As illustrated in FIG. 3, the magnet 24 is covered with the magnet cover 25, thereby preventing the magnet 24 from scattering around. An end face of the magnet cover 25 includes bent portions 25A formed as illustrated in FIG. 3, thereby preventing the magnet 24 from scattering in a radial or axial direction.

Note that an end portion of the bus bar 21 is connected to an input terminal 27 via a bus bar 26 that passes through the flange 14. The bus bar 21 is wired so as to be connected to a coil of each phase. Power of U phase, V phase, and W phase, input through the input terminal 27, is input to the bus bar 21.

The basic configuration of the rotating electrical machine 11 has been described above, and no further description thereof will be given. Next, the technical features of the present invention will be described.

A housing-side bearing holding part 28 is formed in the center of a bottom 13A of the housing 13. The housing-side bearing holding part 28 protrudes inward (toward the rotor in the axial direction) from the bottom 13A.

With the configuration having the protrusion, the axial length of the rotating electrical machine 11 can be reduced. That is, by arranging the housing-side bearing holding part 28 closer to the end face of the rotor 15, the space existing around the end face of the rotor 15 can be used as a space where the housing-side bearing holding part 28 is placed.

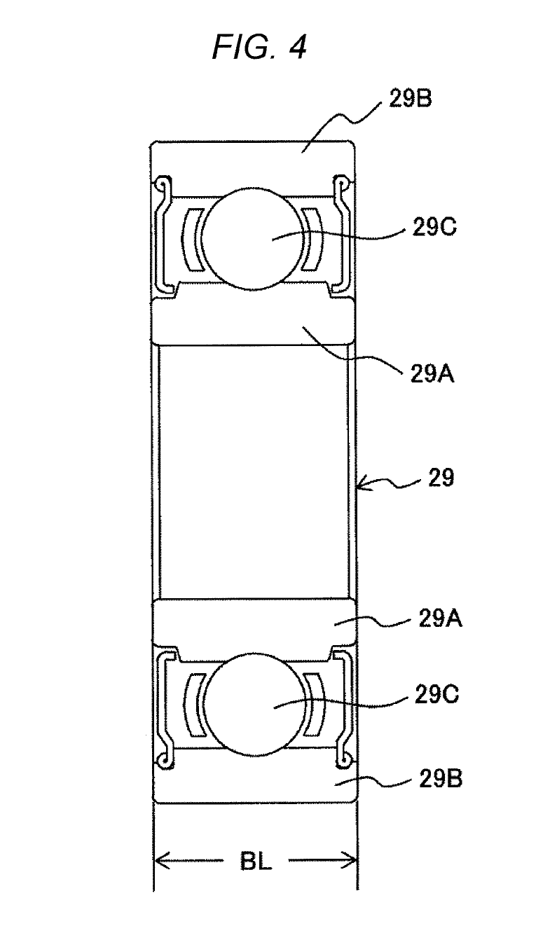

A housing-side bearing 29 is housed inside the housing-side bearing holding part 28, and includes an inner ring 29A and an outer ring 29B. As illustrated in FIG. 4, the housing-side bearing 29 includes the inner ring 29A and the outer ring 29B, and rolling elements 29C, in the shape of a ball, between the inner ring 29A and the outer ring 29B. With this configuration, the inner ring 29A and the outer ring 29B can smoothly rotate relative to each other via the rolling elements 29C. Note that the housing-side bearing 29 has a similar configuration to a flange-side bearing, described later, arranged on the side of the flange 14.

The housing-side bearing 29 is housed in the housing-side bearing holding part 28. The housing-side bearing holding part 28 includes a small-diameter portion 28A and a large-diameter portion 28B. The small-diameter portion 28A regulates the movement of the outer ring 29B of the housing-side bearing 29 toward the rotor 15. The large-diameter portion 28B regulates the movement of the outer ring 29B in the radial direction.

A retaining ring 30 is engaged with the large-diameter portion 28B on the opposite side of the small-diameter portion 28A of the housing-side bearing holding part 28 across the housing-side bearing 29. The housing-side bearing 29 is arranged between the retaining ring 30 and the small-diameter portion 28A. The distance between the retaining ring 30 and the small-diameter portion 28A is somewhat larger than the width BL of the housing-side bearing 29 illustrated in FIG. 4, so that the housing-side bearing 29 can move.

A housing-side shaft 22A of the rotor shaft 22 is press fit and fixed into, and firmly connected to, the inner ring 29A of the housing-side bearing 29.

The outer ring 29B of the housing-side bearing 29, on the other hand, is arranged to face the large-diameter portion 28B of the housing-side bearing holding part 28 with a gap therebetween. As a result, the housing-side bearing 29 can follow the axial movement of the rotor shaft 22 and move in the axial direction inside the housing-side bearing holding part 28. This movement, however, is regulated by the small-diameter portion 28A. Therefore, the housing-side bearing 29 can only move in a situation where the small-diameter portion 28A suppresses the backlash of the rotor shaft 22 in the axial direction and the rotating electrical machine 11 is rotated. The reason for this will be described later.

Next, the configuration of a flange-side bearing will be described. A flange-side bearing holding part 31 is formed in the center of the flange 14. The flange-side bearing holding part 31 protrudes inward (toward the rotor in the axial direction) from a flange face 14A.

With this configuration having the protrusion, the axial length of the rotating electrical machine 11 can be reduced. That is, by arranging the flange-side bearing holding part 31 closer to the end face of the rotor 15, the space existing around the end face of the rotor 15 can be used as a space where the flange-side bearing holding part 31 is placed. This configuration is similar to that of the housing-side bearing holding part 28 and, therefore, the axial length of the rotating electrical machine 11 can be even more reduced.

The flange-side bearing holding part 31 also functions as a preload imparting part in which a preload imparting member is housed. The preload imparting part will be described later.

A flange-side bearing 32 is housed inside the flange-side bearing holding part 31, and includes an inner ring 32A and an outer ring 32B.

The flange-side bearing 32 includes the inner ring 32A and the outer ring 32B, and rolling elements 32C, in the shape of a ball, between the inner ring 32A and the outer ring 32B. Therefore, the inner ring 32A and the outer ring 32B can smoothly move relative to each other via the rolling elements 31C.

The flange-side bearing 32 is housed in the flange-side bearing holding part 31. The flange-side bearing holding part 31 includes a small-diameter portion 31A and a large-diameter portion 31B. The small-diameter portion 31A regulates the movement of the outer ring 32B of the flange-side bearing 32 toward the rotor 15. Note that this movement is regulated through the preload imparting member described later. Furthermore, the large-diameter portion 31B regulates the movement of the outer ring 32B in the radial direction.

A preload imparting part 33 is formed on the side of the small-diameter portion 31A of the flange-side bearing holding part 31, that is, on the side of the rotor 15 across the flange-side bearing 32. That is, a housing space serving as the preload imparting part 33 is formed between the small-diameter portion 31A and the flange-side bearing 32.

The axial length of the large-diameter portion 31B excluding the preload imparting part 33 is set larger than the width of the flange-side bearing 32, so that the flange-side bearing 32 can move.

A flange-side shaft 22B of the rotor shaft 22 is press fit and fixed into, and firmly connected to, the inner ring 32A of the flange-side bearing 32.

On the other hand, the outer ring 32B of the flange-side bearing 32 is arranged to face the large-diameter portion 31B of the flange-side bearing holding part 31 with a gap therebetween. As a result, the flange-side bearing 32 can follow the axial movement of the rotor shaft 22 and move in the axial direction inside the flange-side bearing holding part 31.

A wave washer 34 serving as the preload imparting member is arranged inside the preload imparting part 33 described above. The wave washer 34 is configured to generate an elastic force toward the opposite side of the rotor 15 across the small-diameter portion 31A.

With the elastic force, the flange-side bearing 32 is pushed rightward in the drawing, and the outer ring 29B of the housing-side bearing 29 moves to the position regulated by the small-diameter portion 28A of the housing-side bearing holding part 28. This is because the flange-side bearing 32 and the housing-side bearing 29 move integrally, since the rotor shaft 22 is fixed to the inner ring 32A of the flange-side bearing 32 and the inner ring 29A of the housing-side bearing 29.

At this time, the wave washer 34 biases the small-diameter portion 31A of the flange-side bearing holding part 31 toward the rotor 15 (leftward in the drawing) through a reaction force and, consequently, pushes the entire flange 14 toward the bottom 13A of the housing 13.

Using the wave washer 34 as the preload imparting member can reduce the axial length of the rotating electrical machine 11, because the wave washer 34 has a small thickness in the direction of generating the elastic force. Alternatively, a spring washer, for example, can be used instead of the wave washer 34 to produce a similar effect.

The present embodiment is excellent in assemblability since the bearing including the wave washer 34 (preload imparting member) is formed on the side of the flange 14. That is, the present embodiment can achieve the ease of assembly since the rotor shaft 22 can be press fit into the flange 14 after the wave washer 34 and the flange-side bearing 32 are assembled into the flange-side bearing holding part 31 of the flange 14.

The opening 17 of the housing 13 extends to the vicinity of a portion where the rotor 15 and the stator 16 are arranged. The flange 14 is fixed at this portion.

It is desirable that the flange 14 and the housing 13 be basically fixed to each other through shrinkage fitting, press fitting, an adhesive or the like, that is, without using a fixing component. Even in the case where a fixing component is necessary in terms of design, the size of the fixing component can be reduced since the preload imparting member 34 has a function to hold the flange 14. As a result, the size of the rotating electrical machine can be reduced.

Next, the functions and effects of the assembled rotating electrical machine 11 according to the present embodiment will be described.

In the state illustrated in FIG. 2, the housing 13 and the flange 14 are fixed to each other. Therefore, the wave washer 34 generates an elastic force to move the flange-side bearing 32 in a direction away from the rotor 15 (rightward in the drawing) from the small-diameter portion 31A of the flange-side bearing holding part 31.

The outer ring 32B of the flange-side bearing 32 can move relative to the large-diameter portion 31B of the flange-side bearing holding part 31. Therefore, the inner ring 32A and the flange-side shaft 22B of the rotor shaft 22 fixed to the inner ring 32A also move accordingly.

When the rotor shaft 22 moves rightward in the drawing, the housing-side shaft 22A of the rotor shaft 22 and the inner ring 29A of the housing-side bearing 29 fixed to the housing-side shaft 22A move rightward. In addition, the outer ring 293 of the housing-side bearing 29 can move relative to the large-diameter portion 28B of the housing-side bearing holding part 28, and therefore, the entire housing-side bearing 29 moves rightward.

When the housing-side bearing 29, the rotor shaft 22, and the flange-side bearing 32 move rightward, and the outer ring 29B of the housing-side bearing 29 comes into contact with the small-diameter portion 28A of the housing-side bearing holding part 38 and the movement of the outer ring 29B is regulated, the rotor 15 maintains its rotation at that position.

This makes it possible to suppress abnormal noise to be generated by the backlash of the rotor shaft 22 of the rotor 15 in the axial direction.

Meanwhile, with the outer ring 29B of the housing-side bearing 29 being in contact with the small-diameter portion 28A of the housing-side bearing holding part 38 and the movement of the outer ring 29B regulated, the wave washer 34 is located between the small-diameter portion 31A of the flange-side bearing holding part 31 and the inner ring 32A of the flange-side bearing 32 fixed to the flange-side shaft 22B. Therefore, the wave washer 34 applies a reaction force toward the small-diameter portion 31A of the flange-side bearing holding part 31 from the flange-side bearing 32.

In this manner, the force is applied to the flange 14 leftward in the drawing, making it possible to enhance the effect of integrally holding the housing 13 and the flange 14.

As a result, the housing 13 and the flange 14 can be fixed to each other with a relatively weak fixing force through mild shrinkage fitting or press fitting. This makes it unnecessary to use a fixing component, or can reduce the size of the fixing component used.

This makes it possible to eliminate, or reduce the size of, the fixing screw that has been used to fix the housing and the flange. Therefore, the outer shape of the rotating electrical machine can be made small by a portion corresponding to the fixing portion, thereby reducing the size of the rotating electrical machine. Alternatively, the housing and the flange can be fixed to each other by interposing a fixing ring such as a C ring therebetween instead of the fixing screw. Also in this case, the shape of the C ring can be made small.

Since the fixing component can be eliminated or the size thereof can be reduced, the outer diameter of the stator can be increased accordingly, within a constant outer shape. The increase in outer diameter of the stator may improve output performance.

Furthermore, in the case where the outer diameter of the stator is increased to obtain the same output performance, the axial length of a magnetic circuit and the weight of a magnet and the like can be reduced, providing advantages in terms of weight reduction and manufacturing cost.

Note that the preload imparting member 34 is provided on the side of the flange 14 in the embodiment described above. Alternatively, however, the bearing structure on the side of the flange 14 may be provided on the side of the housing 13.

In this case, the wave washer 34 serving as the preload imparting member can be interposed between the housing-side bearing 29 and the small-diameter portion 28A of the housing-side bearing holding part 28 illustrated in FIG. 2, and the retaining ring 30 can be engaged with the large-diameter portion 31B of the flange-side bearing holding part 31.

1. A rotating electrical machine comprising:
a stator; and
a rotor,
the stator and the rotor being housed in a chassis including a housing and a flange,
wherein both ends of a rotor shaft of the rotor are rotatably supported by a housing-side bearing and a flange-side bearing, the housing-side bearing being housed in a housing-side bearing holding part provided in the housing, the flange-side bearing being housed in a flange-side bearing holding part, and
a preload imparting member is attached to one of the bearings, the preload imparting member being configured to bias the rotor shaft in one direction and to apply a biasing force to make the housing and the flange come close to each other.

2. A rotating electrical machine comprising:
a stator; and
a rotor,
the stator and the rotor being housed in a chassis including a housing and a flange,
wherein both ends of a rotor shaft of the rotor are rotatably supported by a housing-side bearing and a flange-side bearing, the housing-side bearing being housed in a housing-side bearing holding part provided in the housing, the flange-side bearing being housed in a flange-side bearing holding part,
inner rings of both of the bearings provided at both ends of the rotor shaft are fixed to the rotor shaft,
outer rings of both of the bearings are arranged at both of the bearing holding parts movably in an axial direction of the rotor, and
a preload imparting member is attached to one of the bearings, the preload imparting member being configured to bias the rotor shaft in one direction and to apply a biasing force to make the housing and the flange come close to each other.

3. The rotating electrical machine according to claim 2,
wherein the housing has a shape of a bottomed cylinder with an opening at one end,
the housing-side bearing holding part is formed near the center of a bottom of the housing,
the flange has a flange face fixed to the opening,
the flange-side bearing holding part is formed near the center of the flange face, and
the preload imparting member is arranged at one of the bearing holding parts.

4. The rotating electrical machine according to claim 2,
wherein the housing has a shape of a bottomed cylinder with an opening at one end,
the housing-side bearing holding part is formed near the center of a bottom of the housing,
the flange has a flange face fixed to the opening,
the flange-side bearing holding part is formed near the center of the flange face,
both of the bearing holding parts are formed while protruding toward the rotor, and
the preload imparting member is arranged at a protruding portion of one of the bearing holding parts.

5. The rotating electrical machine according to claim 3,
wherein both of the bearing holding parts include small-diameter portions with a reduced outer diameter on the side of the rotor and large-diameter portions with a larger diameter than the small-diameter portions,
both of the bearings are arranged at portions of the small-diameter portions and the large-diameter portions of both of the bearing holding parts,
the small-diameter portion of one of the bearing holding parts constitutes a movement regulating position for one of the bearings arranged at the one bearing holding part, and
the preload imparting member is arranged between the small-diameter portion of the other bearing holding part and the other bearing arranged at the other bearing holding part, the preload imparting member being configured to bias the one bearing toward the small-diameter portion of the one bearing holding part.

6. The rotating electrical machine according to claim 3,
wherein the flange is fixed to the opening of the housing by a fixing method not using a fixing component.

7. The rotating electrical machine according to claim 6, wherein the flange is fixed to the opening of the housing through shrinkage fitting.

8. The rotating electrical machine according to claim 4,
wherein both of the bearing holding parts include small-diameter portions with a reduced outer diameter on the side of the rotor and large-diameter portions with a larger diameter than the small-diameter portions, both of the bearings are arranged at portions of the small-diameter portions and the large-diameter portions of both of the bearing holding parts,
the small-diameter portion of one of the bearing holding parts constitutes a movement regulating position for one of the bearings arranged at the one bearing holding part, and
the preload imparting member is arranged between the small-diameter portion of the other bearing holding part and the other bearing arranged at the other bearing holding part, the preload imparting member being configured to bias the one bearing toward the small-diameter portion of the one bearing holding part.

9. The rotating electrical machine according to claim 4,
wherein the flange is fixed to the opening of the housing by a fixing method not using a fixing component.
